(19) United States
(12) Patent Application Publication
(10) Pub. No.: US 2018/0342776 A1
(43) Pub. Date: Nov. 29, 2018

(54) SODIUM-AIR BATTERY COMPRISING HIGH-CONCENTRATION ELECTROLYTE

(71) Applicants: Hyundai Motor Company, Seoul (KR); Kia Motors Corporation, Seoul (KR); Seoul National University R&DB Foundation, Seoul (KR)

(72) Inventors: Won Keun KIM, Seoul (KR); Jin Soo KIM, Suwon-si (KR); Kyoung Han RYU, Yongin-si (KR); Ho Taek LEE, Seoul (KR); Ki Suk KANG, Seoul (KR); Hyeok Jun PARK, Seoul (KR); Young Joon BAE, Seoul (KR)

(73) Assignees: Hyundai Motor Company, Seoul (KR); Kia Motors Corporation, Seoul (KR); Seoul National University R&DB Foundation, Seoul (KR)

(21) Appl. No.: 15/845,807

(22) Filed: Dec. 18, 2017

(30) Foreign Application Priority Data
May 24, 2017 (KR) 10-2017-0063848

(51) Int. Cl. H01M 12/08; H01M 10/0568; H01M 10/054; H01M 10/0569; H01M 12/06; H01M 2/16; H01M 4/86

(52) U.S. Cl. CPC H01M 12/08; H01M 10/0568; H01M 10/054; H01M 10/0569; H01M 2300/0002; H01M 2/1673; H01M 4/8663; H01M 2300/0025; H01M 12/06

(57) ABSTRACT

Disclosed herein is a sodium-air battery comprising a high-concentration electrolyte which can increase the chemical stability of the battery material and the discharge product in the sodium-air battery. The use of a liquid electrolyte comprising an ether-based solvent and a sodium salt at a concentration of 4 M or less but exceeding 0.5 M can significantly increase the chemical stability of the sodium-air battery and can suppress the formation of dendrites on the anode.

### CROSS-REFERENCE TO RELATED APPLICATION

The present application claims priority to Korean Patent Application No. 10-2017-0063848 filed May 24, 2017, the entire contents of which is incorporated herein for all purposes by this reference.

### BACKGROUND OF THE INVENTION

### Field of the Invention

The present invention relates to a sodium-air battery comprising a high-concentration electrolyte which can increase the chemical stability of a battery material and a discharge product in the sodium-air battery.

### Description of Related Art

A lithium-air battery, which is receiving attention as a next-generation high-capacity battery, exhibits high energy density due to its use of oxygen which is lightweight. However, current lithium-air batteries have the low efficiency and reversibility thereof.

As an alternative thereto, Korean Patent Application Publication No. 10-2014-0144245 discloses a sodium-air battery. Unlike a lithium-air battery, a sodium-air battery produces a discharge product in the form of superoxide and has considerably low charge overvoltage, high efficiency and large capacity.

The sodium-air battery forms discharge products that are different than those initially reported. This may be due to the chemical sensitivity of a battery system. Since this has resulted in low efficiency, such sodium-air batteries have failed to meet expectations. Specifically, in recent theories, sodium superoxide, which is a discharge product of a sodium-air battery, may dissolve and dissociate in a liquid electrolyte and thus generate a sodium ion and an oxygen radical anion. The generated oxygen radical anion manifests high reactivity with the liquid electrolyte in the battery, like active oxygen, and consequently, side reactions in the battery may occur, thus forming byproducts. Such byproducts need high overvoltage upon charging compared to sodium superoxide, which is an initial discharge product. This is an undesirable for a sodium-air battery.

Thus, techniques for preventing the dissolution of sodium superoxide, which is a discharge product, and increasing chemical stability sodium superoxide to thus minimize side reactions in the battery are urgently needed.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a sodium-air battery, which may prevent the dissolution and dissociation of a discharge product in a liquid electrolyte to thus exhibit superior chemical stability and high efficiency.

The aspect of the present invention is not limited to the foregoing, and will be able to be clearly understood through the following description and to be realized by the means described in the claims and combinations thereof.

Various aspects of the present invention are directed to providing a sodium-air battery, as described below.

The sodium-air battery according to an exemplary embodiment of the present invention comprises an anode comprising sodium, a cathode, and a liquid electrolyte. In various exemplary embodiments, the liquid electrolyte comprises an ether-based solvent and a sodium salt having a concentration of about 4 M or less but exceeding about 0.5 M (e.g., about 0.5 M, about 0.6 M, about 0.7 M, about 0.8 M, about 0.9 M, about 1 M, about 1.1 M, about 1.2 M, about 1.3 M, about 1.3 M, about 1.5 M, about 1.6 M, about 1.7 M, about 1.8 M, about 1.9 M, about 2 M, about 2.1 M, about 2.2 M, about 2.3 M, about 2.3 M, about 2.5 M, about 2.6 M, about 2.7 M, about 2.8 M, about 2.9 M, about 3 M, about 3.1 M, about 3.2 M, about 3.3 M, about 3.3 M, about 3.5 M, about 3.6 M, about 3.7 M, about 3.8 M, about 3.9 M, or about 4M.

In various exemplary embodiments of the present invention, the liquid electrolyte may include a sodium salt having a concentration from about 3 M to about 4 M (e.g., about 3 M, about 3.1 M, about 3.2 M, about 3.3 M, about 3.3 M, about 3.5 M, about 3.6 M, about 3.7 M, about 3.8 M, about 3.9 M, or about 4M).

In various exemplary embodiments of the present invention, the ether-based solvent may be selected from the group consisting of diethyleneglycol dimethylether (DEGDME), tetraethyleneglycol dimethylether (TEGDME), dimethoxyethane (DME) and combinations thereof.

In other exemplary embodiments of the present invention, the sodium salt may be selected from the group consisting of NaPF₆, NaBF₄, NaClO₄, NaAsF₆, NaCF₃SO₃, NaN(SO₂F)₂, Na₂SiF₆, NaSbF₆, NaAlCl₄ and combinations thereof.

In various exemplary embodiments of the present invention, the anode may be a sodium metal.

In various exemplary embodiments of the present invention, the cathode may comprise a carbon material, a binder, and a porous current collector.

In various exemplary embodiments of the present invention, the sodium-air battery may further comprise a separator interposed between the cathode and the anode to separate the cathode and the anode from each other.

The sodium-air battery according to an exemplary embodiment of the present invention may be a battery in which a discharge product, sodium superoxide (NaO₂), is formed on the cathode upon discharging.

The sodium-air battery according to an exemplary embodiment of the present invention may be a battery in which a discharge product, sodium superoxide (NaO₂), remains on the cathode for about 60 hr when the battery is allowed to stand in a discharged state.

The sodium-air battery according to an exemplary embodiment of the present invention may be a battery in which a byproduct, sodium peroxide dihydrate (Na₂O₂.2H₂O), is not formed on the cathode upon discharging.

According to an exemplary embodiment of the present invention, a sodium-air battery can prevent sodium superoxide, which is a discharge product, from dissolving and dissociating in an electrolyte, whereby side reactions do not occur, thus realizing superior chemical stability and high efficiency.

Also, according to an exemplary embodiment of the present invention, a sodium-air battery can suppress side reactions, whereby the stability of an anode including sodium is improved, and shorting of the battery due to dendrites does not occur.

The effects of the present invention are not limited to the foregoing, and should be understood to incorporate all effects that can be reasonably inferred from the following description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a sodium-air battery according to an exemplary embodiment of the present invention;

FIG. 2 shows the results of X-ray diffraction spectrometry of a cathode when the sodium-air battery of each of Example 1 and Comparative Example according to an exemplary embodiment of the present invention is discharged at a discharge capacity of 1 mAh;

FIG. 3 shows the results of X-ray diffraction spectrometry of a cathode at an interval of 4 hr in a liquid electrolyte containing a sodium salt dissolved at a concentration of 0.5 M when the sodium-air battery of Comparative Example according to an exemplary embodiment of the present invention is discharged;

FIG. 4 shows the results of X-ray diffraction spectrometry of a cathode at a predetermined time interval in a liquid electrolyte containing a sodium salt dissolved at a concentration of 4 M when the sodium-air battery of Example 1 according to an exemplary embodiment of the present invention is discharged;

FIG. 5 shows the results of X-ray diffraction spectrometry of a cathode at an interval of 1 day in a liquid electrolyte containing a sodium salt dissolved at a concentration of 3 M when the sodium-air battery of Example 2 according to an exemplary embodiment of the present invention is discharged;

FIG. 6 shows the results of analysis of the cathode of FIG. 5 over time using a scanning electron microscope (SEM);

FIG. 7 shows the charge-discharge curve of the sodium-air battery of Comparative Example according to an exemplary embodiment of the present invention; and

FIG. 8 shows the charge-discharge curve of the sodium-air battery of Example 1 according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

Hereinafter, a detailed description will be given of embodiments of the present invention. The embodiments of the present invention may be variously modified without changing the gist thereof, but are not to be construed as limiting the scope of the present invention.

In the following description of the present invention, it is to be noted that a detailed description of related known functions or constructions will be omitted when it would make the gist of the present invention unclear. As used herein, the term “includes” means that it may further include other components unless otherwise mentioned.

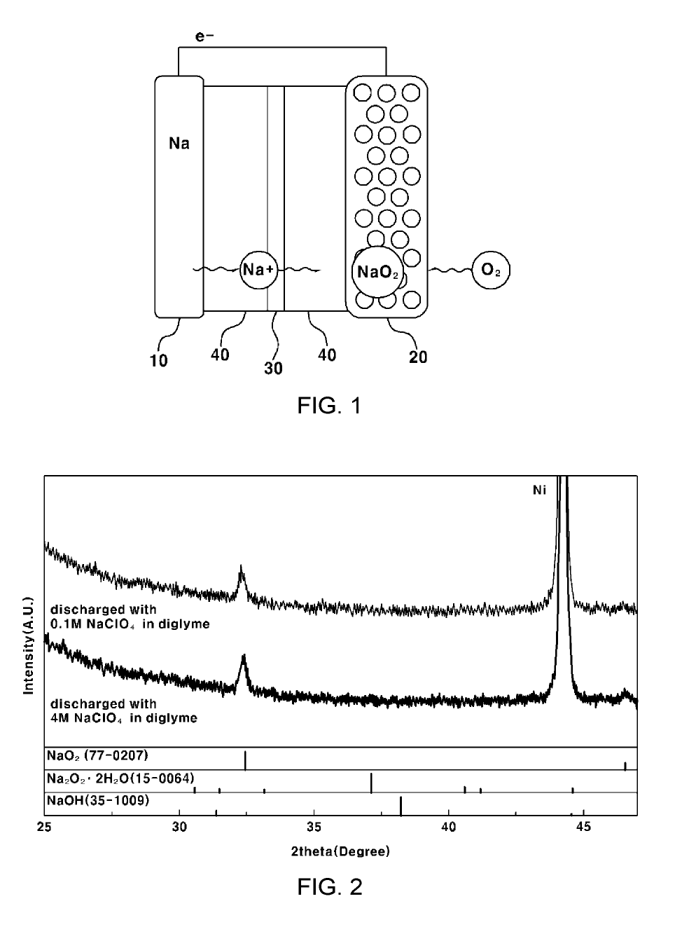

FIG. 1 shows a sodium-air battery according to an exemplary embodiment of the present invention. The sodium-air battery includes an anode 10 including sodium, a cathode 20, a separator 30 for preventing physical contact of the cathode 20 and the anode 10, and a liquid electrolyte 40.

Upon charging and discharging of the sodium-air battery, reduction and oxidation of sodium at the anode 10 and the oxidation and reduction of oxygen introduced from the outside at the cathode 20 occur.

Specifically, upon discharging of the sodium-air battery, sodium is oxidized at the anode 10 to thus produce a sodium ion and an electron, as represented in Reaction Scheme 1 below.

Na→Na⁺+e⁻ [Reaction Scheme 1]

The sodium ion and the electron are transferred to the cathode 20 via the liquid electrolyte and the outer conductor or current collector, respectively. The cathode 20 is porous and thus external air is introduced thereto. Here, oxygen contained in the external air is reduced by the electron and reacts with the sodium ion, thereby forming sodium superoxide (NaO₂), which is a discharge product, at the cathode 20, as shown in Reaction Scheme 2 below.

Na⁺+O₂+e⁻→NaO₂ [Reaction Scheme 2]

The charging reaction proceeds in the opposite direction. Specifically, sodium superoxide (NaO₂), which is a discharge product, is decomposed to thus produce a sodium ion and an electron.

The present inventors have identified the reaction mechanism of the sodium-air battery as mentioned above, and have also ascertained that a sodium ion and an oxygen radical anion are produced due to the dissolution and dissociation of a discharge product, sodium superoxide (NaO₂), in a liquid electrolyte, and a byproduct such as sodium peroxide dihydrate (Na₂O₂.2H₂O) is formed, attributable to a side reaction in the battery involving the oxygen radical anion.

Sodium peroxide dihydrate (Na₂O₂.2H₂O) requires high overvoltage upon charging compared to sodium superoxide (NaO₂), thus deteriorating the energy efficiency and lifetime of the battery.

Accordingly, the present inventors have repeated studies to solve the above problems and have ascertained that when a liquid electrolyte containing a sodium salt at a high concentration is used, the dissolution and dissociation of sodium superoxide (NaO₂), which is a discharge product, in the liquid electrolyte, may be prevented, and the chemical stability of an organic solvent in the electrolyte is also increased to thus prevent side reactions from occurring.

The technical features of the present invention may be more clearly understood through the specific description and embodiments of the present invention.

According to an exemplary embodiment of the present invention, the liquid electrolyte of the sodium-air battery includes an ether-based solvent and a sodium salt that is dissolved at a high concentration of 4 M or less but exceeding 0.5 M in the ether-based solvent.

The ether-based solvent may be a non-aqueous solvent, which facilitates the dissociation of a sodium salt because of the high dielectric constant thereof and enables the efficient transfer of a sodium ion due to the low viscosity thereof. Specifically, the ether-based solvent may be a non-aqueous solvent selected from the group consisting of diethyleneglycol dimethylether (DEGDME), tetraethyleneglycol dimethylether (TEGDME), dimethoxyethane (DME), and combinations thereof.

The sodium salt may be selected from the group consisting of NaPF₆, NaBF₄, NaClO₄, NaAsF₆, NaCF₃SO₃, NaN(SO₂F)₂, Na₂SiF₆, NaSbF₆, NaAlCl₄ and combinations thereof.

The liquid electrolyte contains the sodium salt at a high concentration of 4 M or less but exceeding 0.5 M, and particularly of 3 M to 4 M. When the concentration of the sodium salt exceeds 0.5 M, dissolution and dissociation of the sodium superoxide (NaO₂), which is a discharge product, in the liquid electrolyte, may be sufficiently suppressed. If the concentration of the sodium salt is too high, the viscosity of the liquid electrolyte may increase and thus the mobility of the sodium ion may decrease. Hence, the upper limit of the concentration thereof is preferably 4 M.

A better understanding of the present invention will be given through the following Examples, which are merely set forth to illustrate, but are not to be construed as limiting the scope of the present invention.

### EXAMPLES

### Example 1

A sodium-air battery was manufactured using a liquid electrolyte containing a sodium salt having a concentration of 4 M through the following procedures.

The anode was a sodium metal having a thickness of 500 μm and a diameter of ½ inch (available from Sigma Aldrich), and a glass fiber filter (GF/A, available from Whatman) was used as a separator.

A carbon material, Ketjen black carbon, and a binder, polytetrafluoroethylene (PTFE), were mixed and applied on a nickel mesh current collector, which was then used as a cathode (oxygen electrode).

The liquid electrolyte was prepared by dissolving the sodium salt, NaClO₄, at a concentration of 4 M in diethyleneglycol dimethylether (DEGDME), which is an ether-based solvent.

A Swagelok-type sodium-air battery was manufactured using the anode, the separator, the cathode and the liquid electrolyte.

### Example 2

A sodium-air battery was manufactured in the same configuration and manner as in Example 1, with the exception that the concentration of the sodium salt of the liquid electrolyte was changed to 3 M.

### Comparative Example

A sodium-air battery was manufactured in the same configuration and manner as in Example 1, with the exception that the concentration of the sodium salt of the liquid electrolyte was changed to 0.1 M.

FIG. 2 shows the results of X-ray diffraction spectrometry of a cathode when the sodium-air battery of each of Example 1 and Comparative Example is discharged at a discharge capacity of 1 mAh. With reference thereto, peaks were observed at about 32.5° in both Example 1 and Comparative Example, from which it can be found that sodium superoxide (NaO₂) was formed as a discharge product.

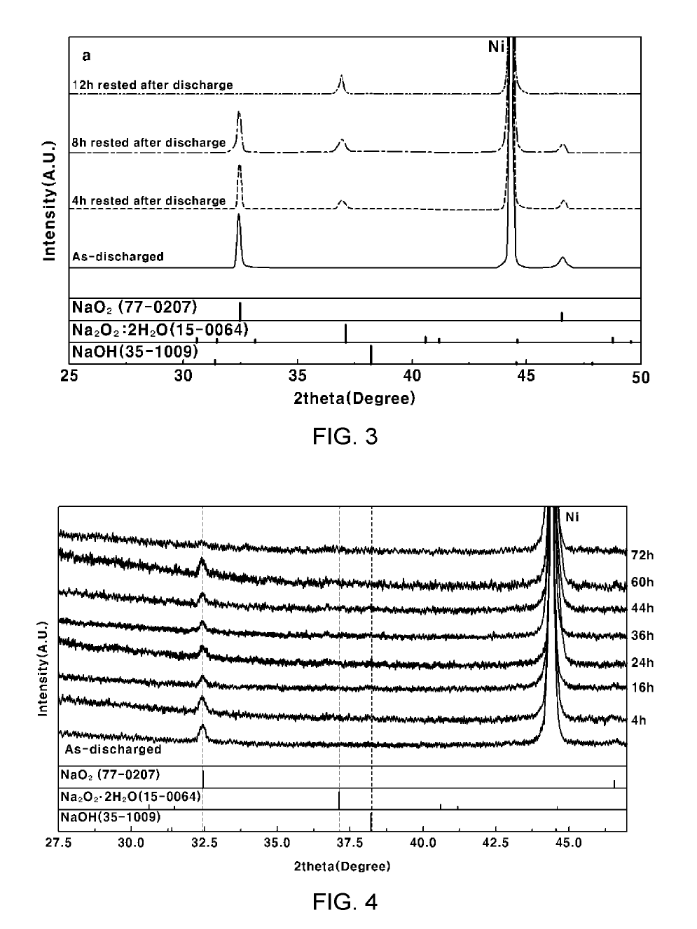

FIG. 3 shows the results of X-ray diffraction spectrometry of a cathode at an interval of 4 hr in the liquid electrolyte containing the sodium salt dissolved at a concentration of 0.5 M when the sodium-air battery of Comparative Example is discharged. As sodium superoxide (NaO₂) immediately after discharge is gradually dissolved in the liquid electrolyte over time, it disappears completely after a rest time of 12 hr, and thus a new peak, corresponding to sodium peroxide dihydrate (Na₂O₂.2H₂O), is observed at about 37°. Thus, when the liquid electrolyte containing the sodium salt having a concentration of 0.5 M is applied to the sodium-air battery, it can be found that a byproduct such as sodium peroxide dihydrate (Na₂O₂.2H₂O) is formed through side reactions due to the dissolution and dissociation of sodium superoxide (NaO₂), which is a discharge product.

FIG. 4 shows the results of X-ray diffraction spectrometry of a cathode at a predetermined time interval in the liquid electrolyte containing the sodium salt dissolved at a concentration of 4 M when the sodium-air battery of Example 1 is discharged. With reference thereto, the peak corresponding to the discharge product, sodium superoxide (NaO₂), was maintained for about 60 hr or more. After 72 hr, even when the amount of sodium superoxide (NaO₂) that was present on the cathode was decreased due to the dissolution in the liquid electrolyte, sodium peroxide dihydrate (Na₂O₂.2H₂O) resulting from side reactions was not formed. Thereby, when the liquid electrolyte containing the sodium salt dissolved at a high concentration of 4 M is applied to the sodium-air battery, dissolution and dissociation of the discharge product, sodium superoxide (NaO₂), may be prevented, and the formation of the byproduct due to side reactions may also be prevented, thus significantly increasing the chemical stability of the battery.

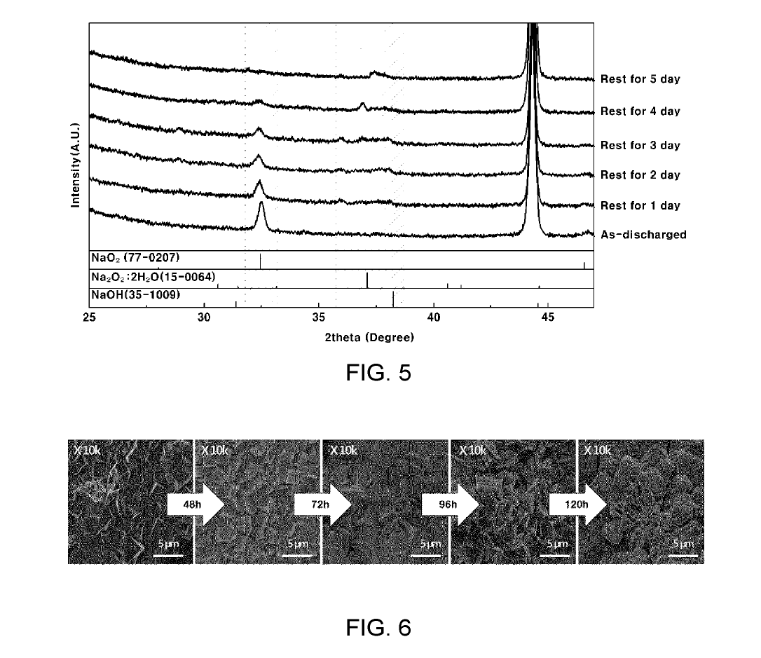

FIG. 5 shows the results of X-ray diffraction spectrometry of a cathode at an interval of 1 day in the liquid electrolyte containing the sodium salt dissolved at a concentration of 3 M when the sodium-air battery of Example 2 is discharged. With reference thereto, the peak corresponding to the discharge product, sodium superoxide (NaO₂), was maintained for about 3 days, and the byproduct, sodium peroxide dihydrate (Na₂O₂.2H₂O), was not formed.

FIG. 6 shows the results of SEM analysis of the cathode of FIG. 5 over time. The sodium superoxide (NaO₂) crystal of the cathode was maintained stable for about 72 hr.

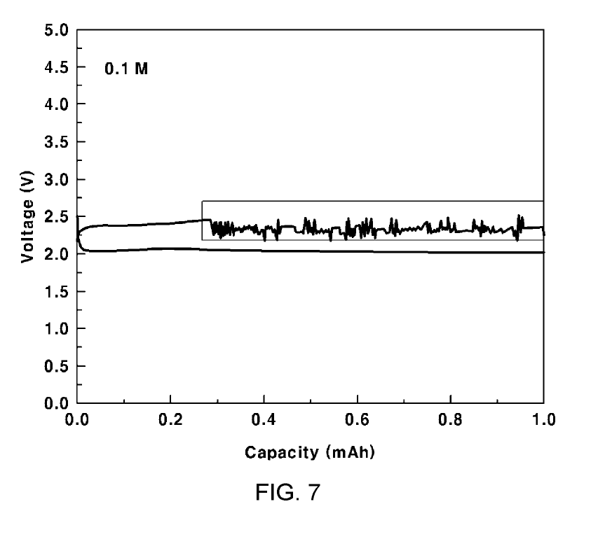

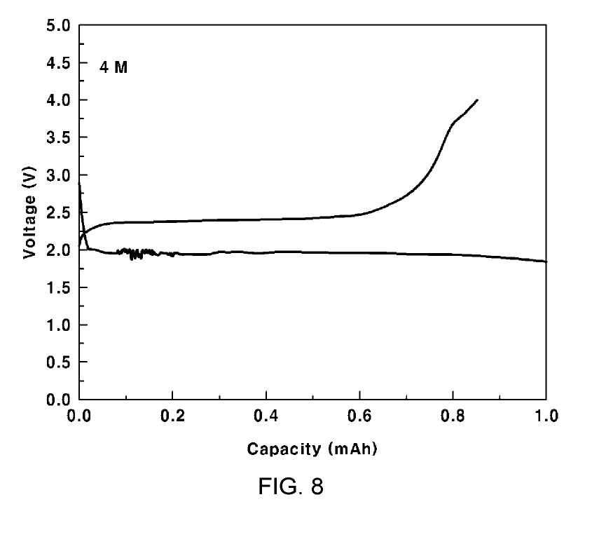

FIG. 7 shows the charge-discharge curve of the sodium-air battery of Comparative Example. With reference thereto, when the liquid electrolyte containing the sodium salt at a low concentration of 0.1 M is used, a soft short circuit may occur due to the formation of dendrites, and thus an unstable charge curve may be shown.

FIG. 8 shows the charge-discharge curve of the sodium-air battery of Example 1. When comparing this charge-discharge curve with that of FIG. 7, the use of the liquid electrolyte containing the sodium salt at a high concentration of 4 M may result in an unchanging charge curve having a stable shape, from which it can be deduced that the charging proceeds and that the stability of the anode composed of the sodium metal is increased.

According to an exemplary embodiment of the present invention, when the sodium-air battery is manufactured using the liquid electrolyte including the ether-based solvent and the sodium salt at a concentration of 4 M or less but exceeding 0.5 M, and particularly, 3 M to 4 M, the chemical stability of the battery can be significantly increased, thus maximizing battery efficiency and improving anode stability, thereby making it possible to perform stable charging without shorting of the battery.

Therefore, the present invention is technically significant in that it identifies the charge-discharge mechanism of the sodium-air battery, which is receiving attention as a next-generation battery, and also in that it completely overcomes the drawbacks thereof.

As described hereinbefore, the present invention has been described in detail with respect to experimental examples and embodiments. However, the scope of the present invention is not limited to the above-described experimental examples and examples, and various modifications and improved modes of the present invention using the basic concept of the present invention defined in the accompanying claims are also incorporated in the scope of the present invention.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sodium-air battery, comprising:
an anode comprising sodium;
a cathode; and
a liquid electrolyte,
wherein the liquid electrolyte comprises an ether-based solvent and a sodium salt having a concentration of 4 M or less but exceeding 0.5 M.

2. The sodium-air battery of claim 1, wherein the liquid electrolyte comprises a sodium salt having a concentration of 3 M to 4 M.

3. The sodium-air battery of claim 1, wherein the ether-based solvent is selected from the group consisting of diethyleneglycol dimethylether (DEGDME), tetraethyleneglycol dimethylether (TEGDME), dimethoxyethane (DME), and combinations thereof.

4. The sodium-air battery of claim 1, wherein the sodium salt is selected from the group consisting of NaPF₆, NaBF₄, NaClO₄, NaAsF₆, NaCF₃SO₃, NaN(SO₂F)₂, Na₂SiF₆, NaSbF₆, NaAlCl₄, and combinations thereof.

5. The sodium-air battery of claim 1, wherein the anode is a sodium metal.

6. The sodium-air battery of claim 1, wherein the cathode comprises a carbon material, a binder, and a porous current collector.

7. The sodium-air battery of claim 1, further comprising a separator disposed between the cathode and the anode to separate the cathode and the anode from each other.

8. The sodium-air battery of claim 1, wherein sodium superoxide (NaO₂) is formed on the cathode after the battery is discharged.

9. The sodium-air battery of claim 8, wherein the sodium superoxide remains on the cathode for about 60 hr when the battery is allowed to stand in a discharged state.

10. The sodium-air battery of claim 1, wherein sodium peroxide dihydrate (Na₂O₂.2H₂O) is not formed on the cathode after the battery is discharged.
